(19) United States
(12) Patent Application Publication
(10) Pub. No.: US 2005/0261613 A1
(43) Pub. Date: Nov. 24, 2005

(54) Device for treatment of animals

(76) Inventor: Bendik Bo, Larvik (NO)

Correspondence Address: DENNISON, SCHULTZ, DOUGHERTY & MACDONALD, 1727 KING STREET, SUITE 105, ALEXANDRIA, VA, 22314, US

(21) Appl. No.: 10/529,766

(22) PCT Filed: Oct. 9, 2003
(86) PCT No.: PCT/NO03/00338

§ 371 Date: May 5, 2005

(30) Foreign Application Priority Data
Oct. 15, 2002 (NO) 20024948

(51) Int. Cl. A61H 1/00

(52) U.S. Cl. 601/70; 601/62; 601/98; 601/100; 119/509; 119/525

(57) ABSTRACT

Device for preventing, restoring and healing treatment of muscles, tendons, joints, joint capsules, etc. of animals and particularly of large animals, includes a plate adapted to temporarily or permanently be arranged on a base where the animal is kept, the plate arranged to be set in vibration by means of at least one drive source. The plate is a functional single layer plate provided with a number of flexible spacers on its lower side to hold the plate a predetermined distance above an even base. The plate may be formed of at least two separate plate elements arranged adjacent to each other along an axis so that each plate element has an inner edge along the axis and an outer edge parallel to and at a distance from the axis.

The present invention relates to a device for the preventive, restoring and healing treatment of animals. The device is suited for treatment of muscles, tendons, joints, joint capsules etc., particularly for larger animals, as well as treatments of gastrointestinal problems such as colic.

### BACKGROUND

It is not uncommon for large animals such as horses to become stiff, or for other reason, require healing or preventive treatment of muscle groups, tendons, joint capsules or joints. This is particularly valid for horses that are exposed to tough loads or strains, such as heavy work, galloping, trotting, or other horse sports.

It is not unusual to treat horses with manual massage or use laser or ultrasound treatment. More often, however, it is necessary to give such treatment only when it has become obvious that the animal is in pain or has a visible injury. This is partly due to the fact that it requires a lot of resources to treat such large animals, and the animals cannot easily express what kind of discomfort they suffer from. Usually, only obvious wounds become treated with such animals.

Galloping and trotting horses are particularly valuable, and are particularly disposed to injuries due to the tough strains they are exposed to during training and competition. In principle there are sufficient resources to treat such animals, however, due to long periods of travels to and from the races, there is often not sufficient time to provide restoring treatment subsequent to each race.

With respect to the effect of ultrasound treatment, it only penetrates the animal's body a few centimetres, and is therefore effective only for certain, local type injuries, if effective at all.

U.S. Pat. No. 4,782,822 describes prior art equipment for treating horses in a box or stall in which a particular floor or base is set to vibrate, such that the vibrations may be transmitted from the horses hooves and legs throughout the entire body of the animal. A disadvantage with the box according to U.S. Pat. No. 4,782,822, is that it is largely based on metal components which are heavy and expensive. Moreover it comprises both an upper and a lower plate (separated by spring coils) which also make it heavier and more expensive. For the same reason the equipment is only suited for application in a small box that is barely large enough for the animal to be treated. The technical jargon for such a box is a “restraint box”, because it permits only very limited amount of freedom of movement, and therefore they are no longer commonly used in animal care. An inherent problem with such restraint boxes is that they easily result in strained animal musculature.

### OBJECTIVES

It is an object of the present invention to provide a device for simple and inexpensive, preventing, restoring and healing treatment of large animals, particularly with respect to injuries and possible injuries in all of the animals muscle groups, tendons, “attachments for tendons”, joints etc.

It is a further object of the present invention to provide a device of said category comprising a vibrating base plate, wherein the device should be easy to assemble and disassemble in the stables where the animals in question are normally kept, so that the animals may be treated in the environment to which they are accustomed.

It is a further object of the invention to provide such equipment as mentioned above which may easily be mass fabricated in certain sizes or fabricated according to specific measurements and which may easily be assembled at the site of use without heavy or machine based tools.

It is still a further object of the invention to provide such a device which is fabricated from easily obtainable light and inexpensive materials.

Finally it is an object of the present invention to provide such a device as mentioned above with improved functionality compared to the prior art equipment within this field.

### THE INVENTION

The above mentioned objects are achieved with the device as defined by claim 1. Preferred embodiments are disclosed by the dependent claims.

The function of the device in its simplest form generally corresponds to the function of the device described in the above discussed U.S. Pat. No. 4,782,822. The drive source or sources set(s) the plate in vibration, thereby a horse or other animal standing on the plate receives a pleasant massage via the skeleton and throughout the body. The massage will in one instance give rise to generally enhanced blood circulation which in turn will have a restoring effect on possible tensional injuries and minor injuries in the form of moderate overloads to tendons and/or joints. This effect occurs at a low vibration intensity. The device according to the invention has also proved effective in the treatment of larger injuries, such as severe gastrointestinal problems/colic and injuries that otherwise did not seem to heal.

Contradictory to the device prior-known from the discussed U.S. Pat. No. 4,782,822, the device according to the invention is well suited for use in common stable rooms for horses or other large animals and does therefore not include separate walls or frames. The device therefore has a very limited vertical extension, and comprises a functional single layer plate that is located on the floor with all required connections, with flexible spacers that will rest against any level surface such as a permanent floor on the site of use. A “functional single layer plate”, is understood to be that the plate does not comprise two separate plate elements separated by spacers like spring coils or the like, such as is the case of the discussed US patent. On the other hand the plate may very well comprise different materials, such as a core of wood fibres or comparatively rigid synthetic material, coated at least on its top side with a flexible, synthetic or natural material. The device is well adapted for prefabrication in a factory and rapid assembly on the site of use without use of heavy tools. In this assembly it is preferred that the plate is made up of at least two separate plate elements that when assembled are positioned adjacent to each other along a common axis. The plate elements may in assembled position still be physically separated from each other or they may be hinged together. In any situation the division into more than one plate element will make it simpler to bring the plate into the room or stable in which it is to be assembled. The plate is preferably prefabricated of a profile and dimension that ensures that in the assembled position it covers substantially the entire floor of the box or stable, or that part of it that is intended for the animal. By such an adaption of the device to the animals normal environment, it is ensured that the animal will relax so that the effect of its use is not diminished by stress and strained musculature.

A major advantage of the plate construction of the present invention as a functional single layer plate is the ease with which such a plate may be dimensioned according to the room in which it is to be used, so that the animals do not have to be transported into a restraint box to be treated. There are also other aspects of this feature. One aspect as mentioned is that the animals become stressed from being placed in a restraint box, resulting in a less than optimal effect of the treatment. Another aspect is that some animals will have to be given sedative medicines to accept being placed in the box, or they may panic and hurt themselves or the people nursing them. A third aspect is that the restraint box requires a disproportionate amount of personnel resources as an animal in a restraint box cannot be left alone at all.

Still another benefit of the device according to the invention is the fact that it may easily be lifted up on edge to be cleaned on both sides, while a connected (two-layer) plate is much more difficult to clean between the two plate layers.

The preferred embodiment wherein the plate is made up of separate plate elements also allows for the inclusion of additional features as elaborated below. These features are based on a design where the plate elements may be arranged pivotally around their centre axis, so that the plate elements may be raised from a substantially horizontal base position to an elevated oblique position.

With respect to the term “large animals” as used herein, primarily means animals like cattle, horses etc., but also other animals with a maximum weight exceeding 30 kg, and preferably exceeding 50 kg.

Subsequently the present invention is discussed in further detail by means of some preferred embodiments as illustrated in the accompanying drawings, where

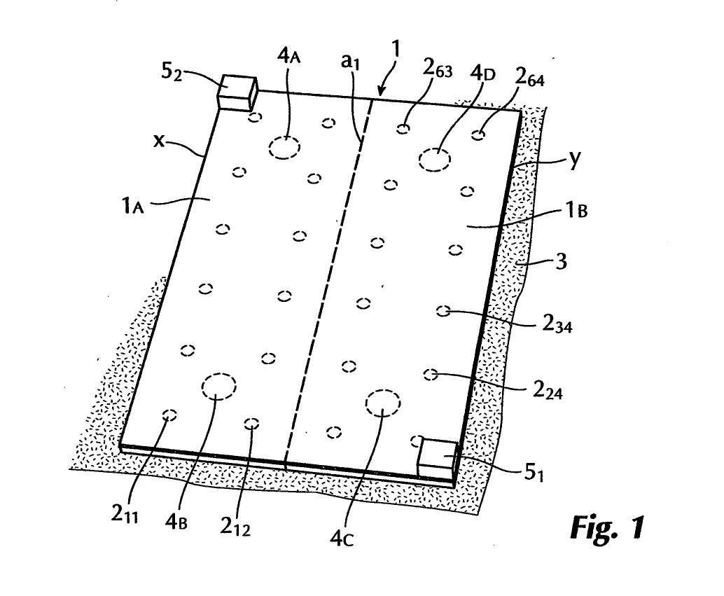

FIG. 1 is a perspective view of an embodiment of the invention where the plate is comprised of two separate plate elements,

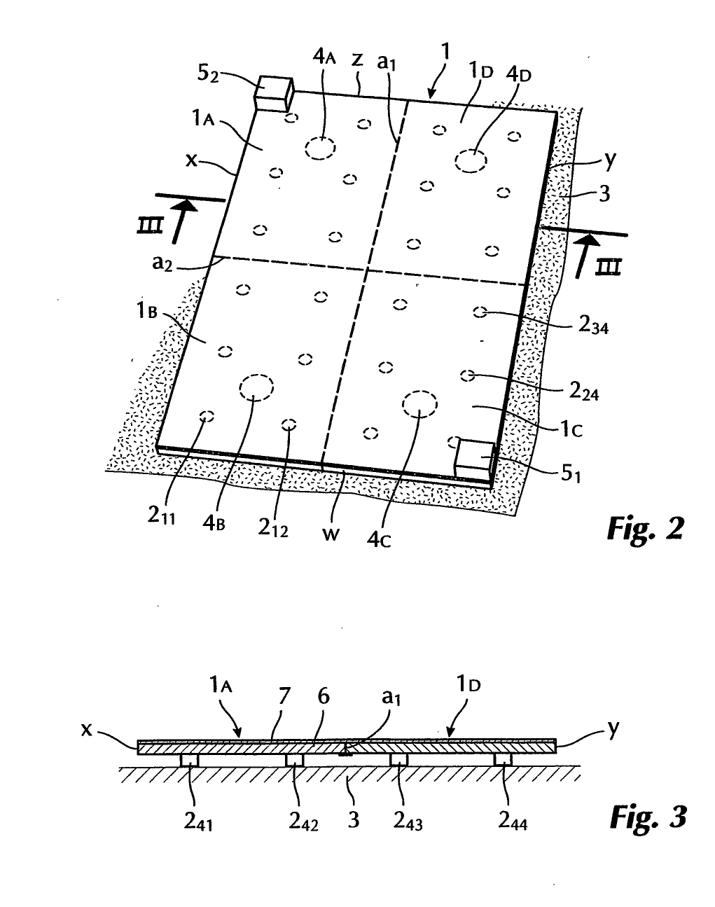

FIG. 2 is a perspective view of a second embodiment of the invention wherein the plate is comprised of four separate plate elements,

FIG. 3 is a sectional view of the embodiment shown in FIG. 2, seen along the line III-III in FIG. 2.

FIG. 1 shows plate 1, comprised of one plate element 1_{A} and one plate element 1_{B}. The parts or elements 1_{A} and 1_{B} are pivotally hinged around a common axis a₁, and have outer edges x and y respectively that are parallel to the axis a₁.

To the lower side of the plate 1 in a matrix arrangement are attached a number of flexible spacer elements or spacers 2₁₁-2₆₄ (24 spacers, a random one of which being denoted 2ₘₙ) adapted to be supported by, and possibly attached to a base 3, like the floor of an ordinary stabling (stable room) for a horse. The upper side of the plate 1 is normally covered by a layer of synthetic or natural rubber material or the like which is comfortable and soft for an animal to stand on, while at the same time providing friction against the animal's legs/hooves. Two electrical motors are arranged in direct contact with plate 1. The motors 5₁ and 5₂ may be of many different types and do not have to be designed particularly for the purpose of the present invention. They may for e.g. be of a kind provided with an eccentric turntable/flywheel, or with a turntable provided with eccentric weight loads. It is particularly preferred that the balance point of the turntable is moveable making its degree of eccentricity adjustable.

Below plate 1 in FIG. 1, as shown with stapled lines, are four bellow cylinders 4_{A}, 4_{B}, 4_{C}, 4_{D}, that are connected to one or more compressors (not shown). When the bellow cylinders are filled with air they provide an elevational force to the plate element under which they are attached. With respect to the device shown in FIG. 2, pairs of two and two of the bellow cylinders are arranged to be filled and emptied synchronously, namely such that bellow cylinders 4_{A} and 4_{B} are filled and emptied at the same time, whilst the bellow cylinders 4_{C} and 4_{D} are also filled and emptied at the same time, but normally at other times than the cylinders 4_{A} and 4_{B}. When the bellow cylinders 4_{A} and 4_{B} are filled, the plate element 1_{A} is lifted from its horizontal position to an elevated oblique position where the inner axis a₁ of the plate element 1_{A} remains substantially in its original position while the outer edge x of the plate element 1_{A} is raised to a vertical level somewhat higher than the elevated top point of the bellow cylinders. The elevational movement of the bellow cylinders may vary, but will typically be in the range of about 5 cm. When e.g. a horse is standing on plate 1, when the plate element 1_{A} is raised, it will sense the movement somewhat similar to how it senses a curve when being transported in a horse trailer behind a car, i.e. the horse will need to use its muscles to adjust for the movement of the plate element to maintain its balance. When carrying out such an adjustment, it will normally lift a foot and put it down in a slightly different position, i.e. it will perform what is commonly referred to as a (through) step, in principle the same action as performed when walking.

Under normal use both motors will be connected in order to set the plate 1 into vibrations. The motors may be supplied from a transformer and/or a frequency transformer (not shown) or the like, so that their effect and/or frequency and thereby the intensity of the plate vibrations may bed controlled. The purpose of applying two or more motors is primarily to ensure an operatable device even if one motor should stop, thereby requiring repair or replacement.

The motors 5₁, 5₂ must be connected to an electrical cable (not shown) for the supply of power, and said cable or cables may be arranged under the plate and connected to the motors from below. The power to the motor(s) may be alternating current from the power grid, it may be power from a mobile device like the electric generator of a car, but it may also be power in the form of air pressure or the like from a pressurized air system. It is preferred that the motors have a rotational axis to which is attached to at least one wheel with eccentric balance weight (weight-eccentric wheel). It is furthermore preferred that the motor is so adapted that its speed may be steplessly varied or varied in a number of discrete steps. The motors may, in principle, be of any kind that is simple and inexpensive and it is therefore preferred that they are electric motors of a “normal” size, particularly with an output between 0, 1 and 2 kW and with a maximum rotational speed of about 4000 rpm.

The motors may also be air-controlled motors that on their output side is similar to the mentioned electric motors with rotational axes and weight-eccentric wheels. Another alternative is air-controlled piston engines with a piston that effects a linear, oscillating movement, i.e. a movement that is set up substantially vertically. Yet another alternative based on pressurized air is air-controlled ball vibrators, where the vibrations are generated by steel balls or the like that are set to rotate on a polished, tempered and closed loop.

The motors 5₁, 5₂ need not be attached directly to plate 1 as shown in FIGS. 1 and 2 It is feasible instead to attach the motor to plate 1 over “piers” (not shown) that may be made in the same material as the plate or in any other material suitable to transmit vibrations, allowing the motors to be placed further away from the area that may be reached by the animal legs. Typically such a pier may be of fibre board (particularly when the core of plate 1 is fibre board) and attached with screws to the lower side close to one of the edges of plate 1, and with dimensions that allow it to extend through an open slot or the like in the wall of the room in question.

The positioning of the motors shown in FIGS. 1 and 2 is randomly chosen. It is convenient when more than one motor is used, that any two motors are separated somewhat from each other. There is however, nothing preventing two or more motors being mounted to one and the same edge of a short end or a long end of the plate. Acceptable positions of the motors may be found by trial and error. It is to be understood that acceptable positions are those where the motors do not negatively interfere with each other in large areas of the plate.

When applying the embodiment of alternatively raising the different elements 1_{A} and 1 1_{B} of the plate respectively during treatment, this is normally done with the aid of a control unit (PLS) that is connected to one or more compressors able to fill the bellow cylinders 4_{A}, 4_{B}, 4_{C}, 4_{D} with air. Said PLS (Programmed Logic S . . . ) will be programmed to conduct regular or erratic filling and emptying of the bellow cylinders on each side of the axis a₁, usually in a pattern that repeats itself but with such a long cycle of repetition that the animal does not recognise the pattern. It is preferred that the bellow cylinders are filled quite rapidly so that an actual compensation is required for the animal to maintain its balance.

FIG. 2 shows a plate 1 corresponding to the one shown in FIG. 1 except that this plate is divided into four separate elements 1_{A}, 1_{B}, 1_{C} and 1_{D}. In addition to the axis a₁ dividing the plate lengthwise, there is an axis a₂ dividing each of the two elements crosswise. The plate elements 1_{A}, 1_{B}, 1_{C} and 1_{D} are hinged in a similar manner along both axises a₁, a₂. Under each of the four plate elements as is also shown in FIG. 1, are arranged four bellow cylinders 4_{A}, 4_{B}, 4_{C}, 4_{D}. Again the bellow cylinders are arranged to cooperate in parallel two and two, but the sectioning of the plate into four elements gives a higher degree of freedom so that the plate elements may be raised in pairs, alternatingly the elements 1_{A} and 1_{B}, 1_{B} and 1_{C}, 1_{C} and 1_{D} as well as 1_{A} and 1_{D} The outer edges of the plate shown in FIG. 2 are given the reference letters x, y, z and w.

When, for e.g. bellow cylinders 4_{A} and 4_{D} are filled with air, the plate elements 1_{A} and 1_{D} are the ones that are raised to an elevated oblique position where the edge z of these plate elements is raised to a vertical level somewhat higher than the elevated top point of the bellow cylinders 4_{A} and 4_{D}, while the axis a₂ remains substantially still.

In the same manner as described above with reference to FIG. 1, is it desirable that the bellow cylinders 4_{A}, 4_{B}, 4_{C}, 4_{D} shown in FIG. 2 are being controlled by a PLS unit being programmed to “run” a certain, repetitive pattern of elevations for each pair of said plate elements.

It is convenient that plate 1 by way of the bellow cylinders is secured to the base 3 so that it does not gradually become displaced relative to the base. “Secured” in this connection means that the plate shall be able to move within the amplitude resulting from the desired vibration, particularly having freedom of movement vertically, but not freedom to move significantly sideways.

It is furthermore convenient that the plate is manufactured in dimensions adapted (tailor-made) to particular stablings (stable rooms) or “boxes” in which the animal in question is kept, either stationary or for transportation. It is, for e.g. convenient to manufacture plate 1 with dimensions marginally smaller than the floor of such stable so that the vibrations of the plate will not be damped by contact with the walls. In the drawings the axis a₁ (and a₂) is shown as dividing plate 1 in substantially equal halves. This represents a convenient embodiment, but not a mandatory feature.

Another location well suited for assembly and use of the device according to the invention, for e.g. when used for cattle, within an area of fencing through which the animals have to move at least once a day. Such a location may be in the passage between a “nightroom” and a “dayroom” that the animals walk through every morning and night, or it may be in an area close to a feeding station, so that the animals, by own choice, can stand on or beside a plate according to the device of the present invention when eating and drinking. For these applications it is evident that the possibility of upscaling is inherent with the functional single layer plate, is very significant.

FIG. 3 is a cross-sectional view of the device according to the invention along the line III-III of FIG. 2. Here plate 1 is shown comprising plate elements 1_{A} and 1_{D} separated by the axis a₁ and with outer edges x and y respectively. The plate elements 1_{A} and 1_{D} comprise a supporting core 6 while a coating 7 of a flexible material, such as rubber or the like, covers their upper surface. The spacers 2ₘₙ may have cylindrical, square or other cross-section. The vital feature of the spacers is that they have the appropriate flexibility to allow propagation of vibrations from the drive sources to the entire plate body. The core 6 of plate 1 and coating 7 constitute the functional single layer plate, contradictory to plates that also constitute a plate element on the opposite side of the flexible spacers 2ₘₙ. The core 6 may typically have a thickness of 20 mm but may also be thinner or thicker, dependent on the choice of material, while coating 7 will normally have a thickness less than 10 mm.

The plate elements 1_{A} and 1_{D} (or 1_{A} and 1_{B}) may, but need not be, hinged together around the axis a1. If the plate elements are not physically hinged together around the axis a₁, they will typically be positioned adjacent to each other with a slit opening in between, the width of which being sufficiently small to ensure that no part of the animal body can get jammed in the slit opening. Typically the slit opening will be less than 2 cm, preferably less than 1 cm, e.g. 0.5 cm.

Normally, the device, according to the invention, will be secured against substantial sideways movement that could possibly lead to unwanted and dangerous displacement of the device. A convenient way of doing this is to provide at least the lower part of at least some of the spacers 2ₘₙ with an aperture (not shown) adapted to receive the upper ends of bolts or the like that are rigidly attached to the base. The apertures in the spacers may be conical or cylindrical with a diameter somewhat larger than the external diameter of said bolts. Thus, the freedom of movement between bolt and spacer will be significant in the vertical direction, but strictly limited in the horizontal direction.

It is convenient that the power connections on drive sources 5₁, 5₂ is controlled by a (cycle) timer, so that the treatment may be automatically stopped after a certain time. Also the activation may optionally be controlled by a timer so that treatments can be started, as well as stopped, automatically.

The elevational elements above that have been exemplified as bellow cylinders 4_{(A-D)} may also be of other types. FIG. 1 shows two bellow cylinders/elevational elements (e.g. 4_{A} and 4_{B})) per plate element, while FIG. 2 shows one bellow cylinder/one elevational element per plate element. It should be noted that these are only exemplifying embodiments as there may be one or more elevational elements both with a configuration of two plate elements and with a configuration of four plate elements 1_{A}, 1_{B}, 1_{C} and 1_{D}.

With respect to the motor construction, this can be of practically any type that is suited to provide desirable vibrations to the plate, and the choice of motor or drive source is therefore not critical. It should be noted, however, that vertical movements of the plate are the ones with most positive effect on an animals joints, and a drive force that only or mainly provides horizontal movement/vibrations to the plate is therefore less well suited. A drive source that is not based on a rotating motor but on the magnetic force from a number of coils supplied with alternating current, is a good alternative and has the advantage that the vibrations will mainly be linear and, may be directed along a vertical axis.

1. Device for preventing, restoring and healing treatment of muscles, tendons, joints, joint capsules, etc of animals and particularly of large animals, comprising a plate (1) adapted to temporarily or permanently be arranged on a base (3) where, in use, the animal is located, said plate (1) being arranged to be set in vibration by means of at least one drive source (5₁,5₂) suited therefore, characterized in that plate (1) is a functional single layer plate provided with a number of flexible spacers (2ₘₙ) on its lower side to hold the plate (1) in a predetermined distance above an even base (3).

2. Device as claimed in claim 1, characterized in that at least one motor (5, 52) is used as said drive source, preferably at least one motor with a weight-eccentric rotating wheel.

3. Device as claimed in claim 2, characterized in that the drive source (5₁, 5₂) is arranged so that its intensity is stepless or discretely variable.

4. Device as claimed in claim 2, characterized in that the drive source (5₁, 5₂) is arranged to be automatically started and stopped by means of a (cycle) timer.

5. Device as claimed in claim 1, characterized in that the drive plate (1) has a core of a light and inexpensive material, such as fibreboard or synthetic material.

6. Device as claimed in claim 1, characterized in that the side of plate (1) intended to face the animal, has a coating (7) of a flexible material providing a desired friction against the animals legs.

7. Device as claimed in claim 1, characterized in that the plate (1) has a shape and size corresponding to the stabling (stable room or box) in which the animal is kept, and constitutes an inner floor therein.

8. Device as claimed in claim 1, characterized in that the driving source (5) output within the range 0.1-2 kW.

9. Device as claimed in claim 1, characterized in that plate (1) comprises at least two separate plate elements (1_{A}, 1_{B}) arranged adjacent to each other with a physical or imaginary common axis (a₁) so that each of the plate elements (1_{A}, 1_{B}) has an inner edge along the axis (a₁) and an outer axis (x and y respectively) parallel to and at a distance from the axis (a₁).

10. Device as claimed in claim 9, characterized in that the plate elements (1_{A}, 1_{B}) are physically hinged together along the axis (a₁).

11. Device as claimed in claim 9, characterized in that the plate elements (1_{A}, 1_{B}) are physically separated from each other along the axis (a₁).

12. Device as claimed in claim 9, characterized in that the plate element (1_{A}) is arranged so that it may be rotated from a substantially horizontal first position to an elevated oblique position where the plate element slants downwards from its outer edge (x) towards the axis (a₁), and that plate element (1_{B}) in corresponding manner is arranged so that it may be rotated from a substantially horizontal first position to an elevated oblique position where the plate element slants downwards from its outer edge (y) towards the axis (a₁).

13. Device as claimed in claim 12, characterized in that plate element (1_{A}) is arranged to be rotated by means of bellow cylinders (4_{A}, 4_{B}) and that plate element (1_{B}) is arranged to be rotated by means of bellow cylinders (4_{C}, 4_{D}).

14. Device as claimed in claims 9, characterized in that the plate (1) is comprised by four plate elements (1_{A}, 1_{B}, 1_{C}, 1_{D}) that are arranged adjacent to each other along mutually crossing axes (a₁, a₂).

15. Device as claimed in claims 14, characterized in that each pair of adjacent plate elements (e.g. 1_{A}, 1_{D}) on the same side of an axis (e.g. a₂) is arranged to be rotated around said axis (a₂) from a substantially horizontal first position to an elevated oblique position where said pair of plate elements (1_{A}, 1_{D}) slants downwards from the outer edge (z) towards the axis (a₂).

16. Device as claimed in claims 15, characterized in that each pair of plate elements (e.g. 1_{A}, 1_{D}) is arranged so that it may be rotated around said axis (a₂) by means of bellow cylinders (e.g. 4_{A}, 4_{D}).

17. Device as claimed in claim 13, characterized in that said bellow cylinders (4_{A}, 4_{B}, 4_{C}, 4_{D}) are connected to at least one compressor.

18. Device as claimed in claim 17, characterized in that said at least one compressor is arranged to be controlled by a PLS to regularly or erratically fill and empty pairs of bellow cylinders (4_{A} and 4_{B}, 4_{B} and 4_{C}, 4_{C} and 4_{D} as well as 4_{D} and 4_{A}) to cause said rotation of plate elements (1_{A} and 1_{B}) or pairs of plate elements (1_{A} and 1_{B}, 1_{B} and 1_{C}, 1_{C} and 1_{D} as well as 1_{D} and 1_{A}.
